(19) United States
(12) Patent Application Publication
(10) Pub. No.: US 2003/0106384 A1
(43) Pub. Date: Jun. 12, 2003

(54) Bearing assembly for axle shaft pinion and final reduction gear for vehicle

(75) Inventors: Kunihiko Yokota, Nara (JP); Kanichi Kouda, Osaka (JP)

Correspondence Address: MCGINN & GIBB, PLLC, 8321 OLD COURTHOUSE ROAD, SUITE 200, VIENNA, VA, 22182-3817, US

(73) Assignee: Koyo Seiko Co., Ltd., Osaka (JP)

(21) Appl. No.: 10/256,237

(22) Filed: Sep. 27, 2002

(30) Foreign Application Priority Data
Dec. 7, 2001 (JP) P2001-374375

(51) Int. Cl. F16H 57/04; F16C 19/38

(52) U.S. Cl. 74/424; 384/548

(57) ABSTRACT

A contact angle (α) of a row of tapered rollers (7) on a pinion shaft 1 is set to be 30°, and made larger than a contact angle (β) of a row of tapered rollers (8) which is 20°. This decreases a distribution of load in a radial direction on the row of the tapered rollers (7), and increases a distribution of load in a radial direction on the row of the tapered rollers (8). In this manner, the load in the radial direction on the row of the tapered rollers (7) and the load in the radial direction on the row of the tapered rollers (8) are made close to each other, so that unbalance of the loads in the radial direction between the two rows of the tapered rollers (7, 8) can be moderated, thus improving the supporting rigidity and the life.

### BACKGROUND OF THE INVENTION

The present invention relates to a bearing assembly for an axle shaft pinion having a double row tapered roller bearing which supports in a cantilever manner a hypoid pinion gear constituting a final reduction gear for a vehicle.

Conventionally, as a double row tapered roller bearing, there has been a bearing assembly for an axle shaft pinion of this type in which a pinion shaft is supported in a cantilever manner to a housing.

In this bearing assembly for the axle shaft pinion, the double row tapered roller bearing has had symmetrical structures in opposite areas in an axial direction with respect to a center plane which radially passes a center in an axial direction, and contact angles of rows of tapered rollers on the opposite areas in the axial direction are also set to be the same.

However, there has been a problem, in the above described conventional bearing assembly for the axle shaft pinion, that supporting rigidity has been low and life of the bearing has been short.

Further, in the conventional double row tapered roller bearing assembly for constituting a pinion unit for example, an outer peripheral face of an outer ring which forms an outer peripheral face of the pinion unit has been engaged with a carrier by tight fit, so that supporting rigidity of the bearing can be enhanced.

However, the above described conventional double row tapered roller bearing assembly has been inferior in fitting performance, when the outer ring of the double row tapered roller bearing is press fitted to an inner peripheral face of the carrier. In particular, there has been such a problem that when the outer ring is press fitted, alignment of holes for bolts for fastening the outer ring to the carrier has been difficult.

### SUMMARY OF THE INVENTION

In view of the above circumstances, an object of this invention is to provide a bearing assembly for an axle shaft pinion and a final reduction gear for a vehicle in which supporting rigidity and life can be improved.

Another object of the present invention is to provide a double row tapered roller bearing assembly and a method for assembling the same in which assembling performance and supporting rigidity can be compatible with each other.

In order to solve the aforesaid object, the invention is characterized by having the following arrangement.

(1) A bearing assembly for an axle shaft pinion in which a pinion shaft is supported in a cantilever manner to a fixed part by a double row tapered roller bearing comprising:

the pinion shaft at which a pinion is to be provided;

a first row of tapered rollers adjacent to the pinion; and

a second row of tapered rollers remote from the pinion with respect to the first row of tapered rollers,

wherein a contact angle of the first row of tapered rollers on the pinion shaft is set to be larger than a contact angle of the second row of tapered rollers on the pinion shaft.

(2) The bearing assembly according to (1), wherein the contact angle of the first row of the tapered rollers is set to be a value larger than 23°, and the contact angle of the second row of the tapered rollers is set to be a value smaller than 23°.

(3) The bearing assembly according to (1), wherein

an inner ring defining first track faces is fixed to the pinion shaft, and an outer ring defining second track faces is fixed to the fixed part, and

the first row of tapered rollers and the second row of tapered rollers are arranged between the first and second track faces.

(4) The bearing assembly according to (1), wherein

the contact angle of the first row of tapered rollers is defined by a contact angle between the first row of tapered rollers and the second track face, and the contact angle of the second row of tapered rollers is defined by a contact angle between the second row of tapered rollers and the second track face.

(5) A final reduction gear for a vehicle comprising a bearing assembly for an axle shaft pinion according to (1) or (2).

(6) A double row tapered roller bearing assembly comprising:

a fixed part, and

a double row tapered roller bearing including an outer ring, engaged with the fixed part,

wherein an outer peripheral face is adapted to be clearance fitted to the fixed part when a pre-load in an axial direction is not applied to the double row tapered roller bearing, and

wherein the outer peripheral face is adapted to be tight fitted or transition fitted to the fixed part by expanding in a radial direction when the pre-load in the axial direction is applied to the double row tapered roller bearing.

(7) The double row tapered roller bearing assembly according to (6), wherein the double row tapered roller bearing includes an inner ring and a plurality of tapered rollers arranged between the outer and inner rings.

(8) The double row tapered roller bearing assembly according to (7), wherein the pre-load is applied to the inner ring so as to expand the outer ring in the radial direction.

(9) The double row tapered roller bearing assembly according to (8), wherein

a rotation shaft is press fitted in the double row tapered roller bearing,

a pinion is provided at one end of the rotation shaft,

a flange is axially movably provided at the other end of the rotation shaft, and

the inner ring is arranged between the pinion and the flange so that the pre-load is applied to the inner ring when the flange is moved toward the pinion in the axial direction.

(10) A method of assembling a double row tapered roller bearing assembly comprising:

engaging a double row tapered roller bearing with a fixed part be clearance fit; and

applying a pre-load to the double row roller bearing by pressing both end faces in an axial direction of the double row tapered roller bearing in a state where a rotation shaft is press fitted in the double row tapered roller bearing, so that an outer ring of the double row tapered roller bearing is expanded in a radial direction by the pre-load and the outer ring is tight fitted or transition fitted to the fixed part.

### BRIEF DESCRIPTION OF THE DRAWINGS

FIG. 1 is a sectional view of a first embodiment of a bearing assembly for an axle shaft pinion according to a first embodiment of the invention.

FIG. 2 is a sectional view of a second embodiment of a double row tapered roller bearing assembly according to a second embodiment of the invention.

### DETAILED DESCRIPTION OF PREFERRED EMBODIMENTS

Now, this invention will be described in detail by way of an embodiment as shown in the drawing.

First Embodiment

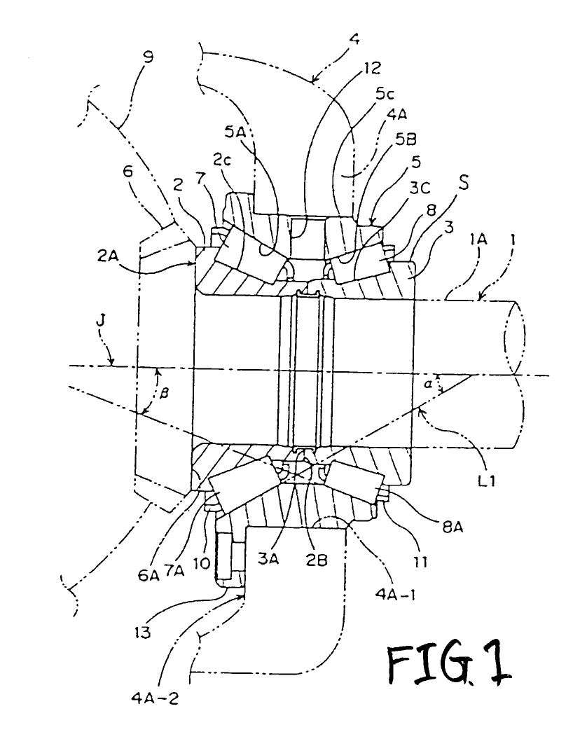

FIG. 1 shows in section an embodiment of the bearing assembly for the axle shaft pinion according to this invention. This embodiment includes a double row tapered roller bearing S which is provided with inner rings 2, 3 fixed by tight fit to a shaft portion 1A of a pinion shaft 1, and an integral outer ring 5 fixed by clearance fit to an inner peripheral face 4A-1 of an opening 4A of a housing 4 which functions as a fixed part.

The above mentioned pinion shaft 1 includes a pinion 6 at its distal end, and this pinion 6 is in mesh with a ring gear 9. This ring gear 9, the pinion shaft 1, the housing 4, and the bearing assembly for the axle shaft pinion in this embodiment constitute, in combination, a final reduction gear for a vehicle.

The above mentioned inner ring 2 is located on the pinion shaft 1 adjacent to the pinion 6, and an end face 2A in an axial direction having a larger diameter is in contact with a back face 6A of the pinion 6. Meanwhile, the above mentioned inner ring 3 is located on the pinion shaft 1 remote from the pinion 6, and an end face 3A in an axial direction having a smaller diameter is in contact with an end face 2B in an axial direction having a smaller diameter of the above described inner ring 2 adjacent to the pinion.

Track faces 2C, 3C of these inner rings 2, 3 are opposed in a radial direction to track faces 5A, 5B of the integral outer ring 5. A row of tapered rollers 7 adjacent to the pinion is arranged between the track face 2C and the track face 5A. A row of tapered rollers 8 remote from the pinion are arranged between the track face 3C and the track face 5B. This row of the tapered rollers 7 is held in an annular cage 10, and respective tapered rollers 7A of this row of the tapered rollers 7 are retained at a predetermined space in a circumferential direction. Meanwhile, the row of the tapered rollers 8 is held in an annular cage 11, and respective tapered rollers 8A of this row of the tapered rollers 8 are retained at a determined space in a circumferential direction. The integral outer ring 5, the inner rings 2, 3, the rows of the tapered rollers 7, 8, and the cages 10, 11 constitute, in combination, the double row tapered roller bearing assembly S.

The integral outer ring 5 is provided with through holes 12 which pass from its outer peripheral face 5C to an inner peripheral face between the track faces 5A and 5B. These through holes 12 are provided in plurality at a determined space in a circumferential direction. In addition, this integral outer ring 5 has a flange 13 adjacent to the pinion, and this flange 13 is fixed to an inner face 4A-2 of the opening 4A in the housing 4.

In this embodiment, a contact angle α of the row of the tapered rollers 7 is set to be 30°, and a contact angle β of the row of the tapered rollers 8 is set to be 20°. It is to be noted that this contact angle α of the row of the tapered rollers 7 means the angle α formed by a phantom line segment L1 in a plane which extends from the track face 5A of the integral outer ring 5 toward a rotation center axis J, with respect to this rotation center axis J. In the same manner, the contact angle β of the row of the tapered rollers 8 means the angle β formed by a phantom line segment in a plane which extends from the track face 5B of the integral outer ring 5 toward the rotation center axis J, with respect to this rotation center axis J.

According to the bearing assembly for the axle shaft pinion having the structure as described above, the contact angle a of the row of the tapered rollers 7 is set to be 30°, and made larger than the contact angle β of the row of the tapered rollers 8 which is 20°. This will decrease a distribution of load in a radial direction on the row of the tapered rollers 7 adjacent to the pinion, and increase a distribution of load in a radial direction on the row of the tapered rollers 8 remote from the pinion, as compared with a case where both the contact angles α, β are the same. In this manner, the load in the radial direction on the row of the tapered rollers 7 adjacent to the pinion and the load in the radial direction on the row of the tapered rollers 8 remote from the pinion are made close to each other, so that unbalance of the loads in the radial direction between the two rows of the tapered rollers 7 and 8 can be moderated, thus improving the supporting rigidity and the life.

Further, in this embodiment, the contact angle α of the row of the tapered rollers 7 has been set to be 30° which is larger than 23°, and the contact angle β of the row of the tapered rollers 8 has been set to be 20° which is smaller than 23°. With this arrangement, according to this embodiment, the high supporting rigidity and long life which have been required in the bearing assembly for the axle shaft pinion can be attained.

On the other hand, in case where the contact angle α of the row of the tapered rollers 7 has been set to be 20°, and the contact angle β of the row of the tapered rollers 8 has been set to be 30°, the supporting rigidity has been decreased by about 40%, and the life has been decreased to almost a half, as compared with this embodiment. Also in case where the contact angle α of the row of the tapered rollers 7 has been set to be 20°, and the contact angle β of the row of the tapered rollers 8 has been set to be 20°, the supporting rigidity has been decreased by about 40%, and the life has been decreased to almost a half. For reference, the supporting rigidity has been measured by a displacement of a teethed part of the pinion 6 in a radial direction.

As described above, according to this embodiment, the supporting rigidity can be increased to about 170%, and the life can be prolonged to about double, as compared with the conventional case (α, β=20°). Thus, the final reduction gear having the high supporting rigidity of the pinion 1 and the long life of the bearing can be realized.

Although in the above described embodiment, the integral outer ring 5 having two rows of the track faces 5A, 5B has been employed as the outer ring 5, two separate outer rings each having a single row of track may be employed. Moreover, although in this embodiment, the final reduction gear for the vehicle has been constituted, this invention can be applied to a bearing assembly in which a pinion shaft is supported to a fixed part in a cantilever manner by means of the double row tapered roller bearing.

As apparent from the foregoing, according to the bearing assembly for the axle shaft pinion of the invention, the contact angle of the row of the tapered rollers on the pinion shaft adjacent to the pinion is set to be larger than the contact angle of the row of the tapered rollers remote from the pinion. This will decrease a distribution of the load in a radial direction on the row of the tapered rollers adjacent to the pinion, and increase a distribution of the load in a radial direction on the row of the tapered rollers remote from the pinion, as compared with a case where both the contact angles are the same. In this manner, the load in the radial direction on the row of the tapered rollers adjacent to the pinion and the load in the radial direction on the row of the tapered rollers remote from the pinion are made close to each other, so that unbalance of the loads in the radial direction between the two rows of the tapered rollers can be moderated, thus improving the supporting rigidity and life.

According to the bearing assembly for the axle shaft pinion of the invention, the contact angle of the row of the tapered rollers adjacent to the pinion is set to be the value larger than 23°, and the contact angle of the row of the tapered rollers remote from the pinion is set to be the value smaller than 23°. With this arrangement, high supporting rigidity and long life which have been required in the bearing assembly for the axle shaft pinion can be attained. For information, in case where the contact angle of the row of the tapered rollers adjacent to the pinion has been made smaller than 23°, the life and the rigidity have been decreased to almost a half.

According to the final reduction gear for the vehicle of the invention, the final reduction gear provided with the bearing assembly for the axle shaft pinion, and having high supporting rigidity of the pinion shaft and long life of the bearing can be realized.

Second Embodiment

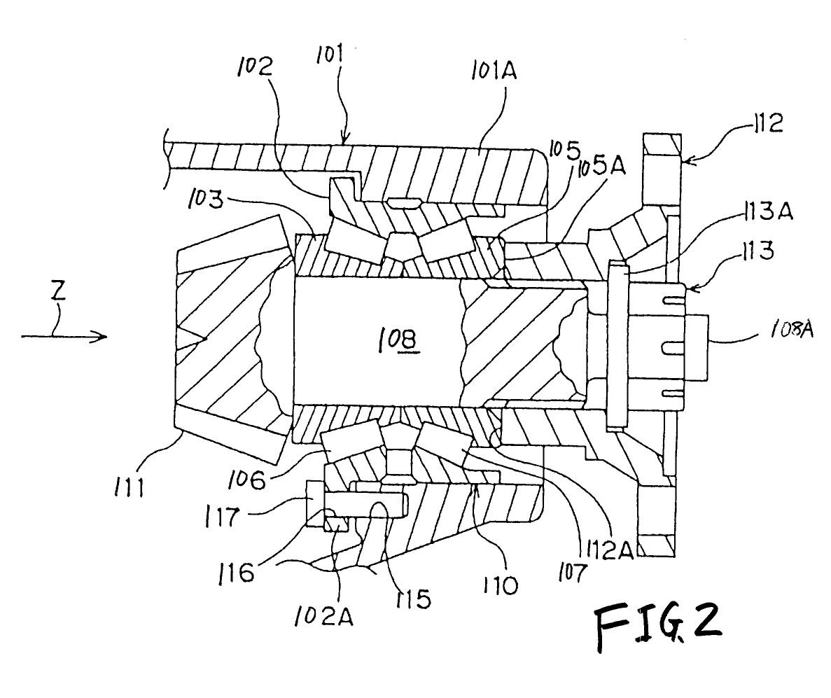

FIG. 2 shows an embodiment of the double row tapered roller bearing assembly according to this invention. A double row tapered roller bearing 110 in this embodiment includes an outer ring 102 which is inserted for engagement with an inner face of an engaging part 101A of a carrier 101 functioning as a fixed part, in an axial direction (in a direction of an arrow Z) to be tight fitted thereto. The above described double row tapered roller bearing 110 includes a first inner ring 103 and a second inner ring 105. A plurality of tapered rollers 106 are arranged between this first inner ring 103 and the above described outer ring 102 at a determined space in a circumferential direction. There are also arranged, between the above described second inner ring 105 and the above described outer ring 102, a plurality of tapered rollers 107 at a determined space in a circumferential direction. These first and second inner rings 103, 105 are engaged with an outer peripheral face of a pinion shaft 108 by tight fit, and clamped from opposite ends in an axial direction by means of a pinion gear 111 at a distal end of the pinion shaft 108 and a companion flange 112.

An inner peripheral face of this companion flange 112 is serration engaged with the outer peripheral face of the pinion shaft 108, and pressed with a washer 113A of a washer faced nut 113 which is screwed on a male thread portion 108A of the pinion shaft 108, in an axial direction (in a direction opposite to the direction of the arrow Z). The companion flange 112 which has been pressed in the axial direction with the washer 113A presses the second inner ring 105 in the axial direction, thereby to apply a pre-load to the double row tapered roller bearing 110, and the outer peripheral face of the outer ring 102 will be expanded in a radial direction with this application of the pre-load. In this manner, the outer ring 102 is tight fitted to the inner peripheral face of the engaging part 101A of the carrier 101.

Then, the outer ring 102 of this double row tapered roller bearing 110 is fastened to the engaging part 101A by making its flange portion 102A opposed to an end face of the engaging part 101A, by aligning a threaded hole 115 formed in this engaging part 101A with a bolt hole 116 formed in the flange portion 102A, and by inserting a bolt 117 into this bolt hole 116 to be screwed into the threaded hole 115.

In a state where fastening by the above described bolt 117 has been disengaged, and the pre-load by the above described washer faced nut 113 has been removed, the outer ring 102 of this double row tapered roller bearing 110 will be released from the expansion in the radial direction on its outer peripheral face, and come into clearance fit with respect to the engaging part 101A.

Now, assembling steps of the double row tapered roller bearing assembly in this embodiment will be described. As a first step, the outer ring 102 is inserted for engagement with the inner peripheral face of the engaging part 101A of the carrier 101 in the axial direction (in the direction of the arrow Z). A manner of engagement on this occasion is clearance fit. Then, the first inner ring 103 is press fitted to the pinion shaft 108 in an axial direction (in a direction opposite to the direction of the arrow Z), and then, the pinion shaft 108 with this first inner ring 103 press fitted is inserted into the outer ring 102 in the direction of the arrow Z. On this occasion, a plurality of the tapered rollers 106 are disposed between the first inner ring 103 and the outer ring 102.

As a next step, the second inner ring 105 is press fitted to the pinion shaft 108 which has been inserted into the outer ring 102, and further, the companion flange 112 is press fitted to the pinion shaft 108. On this occasion, a plurality of the tapered rollers 107 are disposed between the second inner ring 105 and the outer ring 102.

Finally, the washer faced nut 113 is screwed on the male thread portion 108A of the pinion shaft 108 and tightened, thereby enabling an end face 112A of the companion flange 112 to press an end face 105A of the second inner ring 105 in the axial direction. In this manner, the pre-load is applied to the double row tapered roller bearing 110. Due to this application of the pre-load, the outer peripheral face of the outer ring 102 will be expanded, and come into tight fit with respect to the engaging part 101A of the carrier 101.

As described above, according to this embodiment, when the outer ring 102 is to be incorporated into the engaging part 101A, the outer ring 102 of the above described double row tapered roller bearing 110 is clearance fitted to the above described engaging part 101A, because the pre-load in the axial direction is not applied to the bearing 110, and accordingly, the outer ring 102 can be easily engaged with the engaging part 101A. On the other hand, in the state where the outer ring 102 has been incorporated into the engaging part 101A, the outer ring 102 can be expanded in the radial direction by applying the pre-load to the bearing 10 and tight fitted to the engaging part 101A. As the results, assembling performance and supporting rigidity can be compatible with each other according to this embodiment.

Although in the above described embodiment, the outer ring 102 is so adapted as to be tight fitted to the engaging part 101A when the pre-load has been applied to the double row tapered roller bearing 110, it is to be noted that the outer ring 102 may be set so as to be transition fitted.

As apparent from the foregoing, according to the double row tapered roller bearing assembly of the invention, when the outer ring of the double row tapered roller bearing is incorporated into the fixed part, the outer peripheral face of the outer ring is clearance fitted to the fixed part because the pre-load in the axial direction is not applied to the bearing, and consequently, the outer ring can be easily engaged with the fixed part. On the other hand, in the state where the outer ring has been incorporated into the fixed part, the outer ring can be tight fitted (or snap fitted) to the fixed part by applying the pre-load to the bearing and expanding the outer ring in the radial direction. As the results, according to this invention, assembling performance and supporting rigidity can be compatible with each other.

According to the method for assembling the double row tapered roller bearing assembly of the invention, assembling performance will be improved, because in the above described first step, the double row tapered roller bearing is engaged with the fixed part by clearance fit. Moreover, in the above described second step, the pre-load is applied to the double row tapered roller bearing by pressing both the end faces in the axial direction of the double row tapered roller bearing, in the state where the rotation shaft has been press fitted in the double row tapered roller bearing. Due to this application of the pre-load, the outer ring of the double row tapered roller bearing is expanded in a radial direction, and the outer ring is tight fitted (or transition fitted) to the fixed part. Therefore, according to the assembling method of this invention, while enjoying favorable assembling performance of the bearing, supporting rigidity of the bearing can be also enhanced.

What is claimed is:

1. A bearing assembly for an axle shaft pinion in which a pinion shaft is supported in a cantilever manner to a fixed part by a double row tapered roller bearing comprising:
the pinion shaft at which a pinion is to be provided;
a first row of tapered rollers adjacent to the pinion; and
a second row of tapered rollers remote from the pinion with respect to the first row of tapered rollers,
wherein a contact angle of the first row of tapered rollers on the pinion shaft is set to be larger than a contact angle of the second row of tapered rollers on the pinion shaft.

2. The bearing assembly according to claim 1, wherein the contact angle of the first row of the tapered rollers is set to be a value larger than 23°, and the contact angle of the second row of the tapered rollers is set to be a value smaller than 23°.

3. The bearing assembly according to claim 1, wherein
an inner ring defining first track faces is fixed to the pinion shaft, and an outer ring defining second track faces is fixed to the fixed part, and
the first row of tapered rollers and the second row of tapered rollers are arranged between the first and second track faces.

4. The bearing assembly according to claim 1, wherein
the contact angle of the first row of tapered rollers is defined by a contact angle between the first row of tapered rollers and the second track face, and the contact angle of the second row of tapered rollers is defined by a contact angle between the second row of tapered rollers and the second track face.

5. A final reduction gear for a vehicle comprising a bearing assembly for an axle shaft pinion according to claim 1 or 2.

6. A double row tapered roller bearing assembly comprising:
a fixed part, and
a double row tapered roller bearing including an outer ring, engaged with the fixed part,
wherein an outer peripheral face is adapted to be clearance fitted to the fixed part when a pre-load in an axial direction is not applied to the double row tapered roller bearing, and
wherein the outer peripheral face is adapted to be tight fitted or transition fitted to the fixed part by expanding in a radial direction when the pre-load in the axial direction is applied to the double row tapered roller bearing.

7. The double row tapered roller bearing assembly according to claim 6, wherein the double row tapered roller bearing includes an inner ring and a plurality of tapered rollers arranged between the outer and inner rings.

8. The double row tapered roller bearing assembly according to claim 7, wherein the pre-load is applied to the inner ring so as to expand the outer ring in the radial direction.

9. The double row tapered roller bearing assembly according to claim 8, wherein
a rotation shaft is press fitted in the double row tapered roller bearing,
a pinion is provided at one end of the rotation shaft,
a flange is axially movably provided at the other end of the rotation shaft, and
the inner ring is arranged between the pinion and the flange so that the pre-load is applied to the inner ring when the flange is moved toward the pinion in the axial direction.

10. A method of assembling a double row tapered roller bearing assembly comprising:
engaging a double row tapered roller bearing with a fixed part be clearance fit; and
applying a pre-load to the double row roller bearing by pressing both end faces in an axial direction of the double row tapered roller bearing in a state where a rotation shaft is press fitted in the double row tapered roller bearing, so that an outer ring of the double row tapered roller bearing is expanded in a radial direction by the pre-load and the outer ring is tight fitted or transition fitted to the fixed part.
